(19) United States
(12) Patent Application Publication
(10) Pub. No.: US 2003/0005412 A1
(43) Pub. Date: Jan. 2, 2003

(54) System for ontology-based creation of software agents from reusable components

(76) Inventor: James Thomas Eanes, Smithfield, VA (US)

Correspondence Address: George F. Helfrich, 162 Shasta Drive, Newport News, VA, 23608, US

(21) Appl. No.: 10/117,968

(22) Filed: Jun. 28, 2002

Related U.S. Application Data
(60) Provisional application No. 60/281,691, filed on Apr. 6, 2001.

(51) Int. Cl. G06F 9/44

(52) U.S. Cl. 717/120

(57) ABSTRACT

Provided is a system for the creation of autonomous and semi-autonomous networked and non-networked software agents from reusable software components based on domain-specific ontologies and component metadata to reduce the workload and improve the efficiency of end-users. The reusable software components that this system combines into software agents exist either as individual programming entities, such as C++ classes or Java Beans, as component-based system entities, such as Common Object Request Broker Architecture (CORBA) objects or Component Object Model (COM) clients/servers, as stand-alone applications, as Web Services, or as any other individual software entity. Each knowledge domain of interest for agent processing is described using metadata based on one or more ontologies. Each reusable software component is described by metadata adhering to one or more relevant ontologies, defining the component's relationship(s) with the data and procedural model(s) of the relevant knowledge domain(s). A software program combines software components into software agents based on all available metadata and end-user preferences for agent behavior within the bounds of the given knowledge domain(s) and computer or computer network(s). A set of graphical user interfaces (GUIs) provide end-user creation of agents from reusable components through drag-and-drop component combination and domain-specific agent behavior definition.

This application claims the benefit of U.S. Provisional Application No. 60/281,691, which was filed on Apr. 6, 2001 for “Tool for creation of software agents (Agent Wizard™)”.

### STATEMENT REGARDING FEDERALLY SPONSORED RESEARCH OR DEVELOPMENT

The U.S. Government has a paid-up license in this invention as provided for by the terms of Contract No. DAAHO1-00-C-R054 awarded by the Defense Advanced Research Projects Agency (DARPA), Contract Nos. F30602-010C-0005 and F30602-01-C-0015 awarded by the Office of the Secretary of Defense (OSD), and Contract No. DAAD17-01-C-0023 awarded by the Department of the Army.

### BACKGROUND OF THE INVENTION

1. Technical Field of the Invention

This invention relates generally to software agent assistance of end-user operations, the creation of software agents, and metadata. This invention relates specifically to the use of metadata descriptions based on domain-specific ontologies to combine reusable software components into software agents performing tasks as defined by an end-user in a graphical user interface.

2. Description of the Related Art

Fighting Data Overload. The difficulty in distilling useful information from the vast amounts of data on modern networks is a well-known problem. Though the latter part of the twentieth century has been labeled the Information Age due to the advent of mass communications technologies, it is increasingly difficult to glean useful information from the increasingly large and complex network of data sources. Advances in Internet and Ethernet technologies have provided a gateway through which homes, businesses, and military installations can connect with each other as never before to share and sell all manner of data. However, finding the right data from the right place at the right time and then making sense of that data is often difficult, if not impossible. The military's evolution to network-centric warfare has promised information superiority in the battlespace through the integration of information-rich systems on local and global networks. So far, this approach has provided effective data warehousing. Whether it's a munitions database on a local area network (LAN), a weather database accessed over the Internet, or a secure web page providing details for an upcoming mission, remote data abounds in this new information space. However, the current dependence on disjointed legacy systems with application-specific interfaces limits the amount of useful, personalized information provided to the end-user from the available data. What is needed is a method for end-users to locate, extract and display information from existing and emerging systems relevant to their specific tasks. This requirement includes the retrieval of data from systems with no existing human interfaces and systems whose interfaces are not developed toward the end-user's specific tasks.

In order to provide this level of user-oriented information processing, three major technologies are necessary: 1) autonomous agents performing domain-specific tasks based on user preferences; 2) a distributed information integration solution, allowing agents to perform data location, retrieval, translation, and display functions on local and global networks; and 3) a means for end-users to create specialized agents from reusable components. Autonomous agents have been with us for decades, and there are several efforts underway within the military and commercial sectors to provide distributed information integration solutions for a user-oriented information space. The present invention provides the third necessary technology, a means by which end-users can create the agents that will assist them in their daily operations.

Empowering The End-User. The goal of software development is to somehow improve human experience. Software developers that do not pay enough attention to the end-user's operation of the software will invariably fail to fully meet end-user requirements, either resulting in undesirable software or increasing software life-cycle cost through inefficiency (or both). The logical extension of this precept is to provide the end-user with more control over the software development process. By presenting the component-based programming model underlying the agent creation process to the end-user through an interface that is specific to the end-user's knowledge domain and/or experience level, we empower the end-user by reducing the technical details involved in programming software agents.

The transition to component-based programming can be traced back to the development of object-oriented programming languages, such as Smalltalk and Ada, and leading to more widespread use in C++ and Java. However, there has been a fundamental shift from the concept of an object as an instantiation of a program's internal class to a component as an instantiation of a programming entity responsible for a specific task, regardless of the language used. By this definition, any programming effort (e.g. C++ class, Java applet, Ada application) that can be integrated into a larger programming model by some means (e.g. application programming interface (API), Web Services, etc.) becomes a component. Of course, the value of components is in their reuse, and so the method of integrating each component into a larger application needs to be as simple as possible to foster its reuse by other programmers and projects. Because of the many details involved in writing software, enabling end-user software development requires added layers of high-level interfaces to low-level programming details.

Microsoft has provided an interface layer above the use of sockets, shared memory. and other stovepipe connections by developing the Component Object Model (COM). COM hides the details of client-server connections within the Windows operating system itself. The COM model is based on the concept of automation servers and clients. An automation server is a program that exposes some of its internal functions (methods) for use by other programs (clients). Just like a C++ or Java class that has exposed public methods for use outside of the class, the automation server becomes a reusable component to be extended toward multiple applications. An example of a COM automation server is the Web Server object within Microsoft's Internet Explorer (IE), version 4.0 and higher. The Web Server object exposes IE's internal methods for connecting to the Web and processing and displaying HTML and XML documents. By providing an automation interface to the Web Server object, Microsoft has empowered desktop developers to create sophisticated Web-based applications through reuse of a powerful Web component. In order for a potential client to access an automation server's exposed methods, the client must program toward the server's interface, often represented in a type library defining the names and data types of the exposed methods. Microsoft has provided support for the creation of automation servers and clients within their Visual Studio integrated development environment (IDE). Visual Studio provides automatic functionality for type library generation and for the creation of client interface classes from type libraries. Because the COM plumbing is hidden within Windows, the developer using Visual Studio has the power to create and integrate reusable components with the push of a few buttons. The rub, of course, is the tight integration with the Windows operating system.

In order to provide a more open model for component reuse, the OMG has developed an interface layer called CORBA. CORBA is based on three concepts: 1) there is an Object Request Broker (ORB) responsible for message passing between objects using the Internet Inter-Orb Protocol (IIOP), 2) there is a language, called the Interface Description Language (IDL), for describing the interface(s) an object exposes, and 3) there is an Interface Repository containing object descriptions. CORBA provides component reuse on all major platforms, including Solaris, Irix, Linux, and Windows, by hiding the plumbing within ORBs and Repositories that are not directly integrated with any given operating system. CORBA has become a commercially viable large-scale component integration solution, as demonstrated by its use in several large-scale military projects and its close association with other non-Microsoft efforts, including Sun's development of Java. As Java's object-oriented programming model has evolved to include such component-based models as Java Beans, and eventually Enterprise Java Beans (EJB), the open standards community has fostered the combination of Java and CORBA as an alternative to the Microsoft hegemony.

Given their commercial and open standards support, it is not surprising that both CORBA and COM have become widely used component reuse models. However, with the rise of the Web has come a migration from LAN-based solutions to Web-based solutions, both within corporate infrastructures and between corporations using the business-to-business (b2b) e-commerce model. Though COM and CORBA are the de facto standards in the LAN-based systems integration market, they have failed to successfully scale to the larger distributed networks, including military wide area networks (WANs) and the Internet. Efforts to scale them up include the Distributed Component Object Model (DCOM) from Microsoft and the EJB-powered CORBA Beans initiative by the Technical Resource Connection, neither of which has had much success integrating the Enterprise, largely due to their use of non-firewall-friendly protocols (e.g. IIOP) or attachment to specific underlying technologies (e.g. Windows), as well as the general difficulty programming and debugging their lengthy and sophisticated interfaces. In order to support component reuse in the Web-based Enterprise, industry is moving toward a lightweight, firewall-friendly, platform-independent protocol, along with a programming methodology that makes use of the existing distributed architecture of the Web. The protocol is called the Simple Object Access Protocol (SOAP), and the programming model is called Web Services.

The concept of SOAP-based Web Services is another interface layer over the LAN-based models of COM and CORBA. A Web Service is nothing more than an application (service) registered with a Web server to provide its exposed functionality to other applications (clients). Of course, clients may be services, as well; the designation is strictly directional (i.e. who initiates the request). Each service registers itself with a Web server (and optionally with a service repository) in order to expose its capabilities to potential clients. Standard Web servers on the network become data brokers by passing SOAP messages between clients and services. These SOAP messages are composed of a protocol stack, consisting of an underlying transport layer, which includes the SOAP envelope and the chosen transport protocol (e.g. HTTP), and an additional content layer, which includes elements from a service description language and possibly from any number of domain-specific schemas. Current efforts toward service description include proprietary solutions such as Microsoft's BizTalk.org initiative and open standards such as the Web Services Description Language (WSDL), the electronic business eXtensible Markup Language (ebXML), and the Defense Advanced Research Projects Agency (DARPA) Agent Markup Language-Services (DAML-S). The number of Web Service efforts currently underway and the level of commercial involvement, including Microsoft's new “software as a service” .NET initiative, make it clear that the Web Service model represents the latest stage in the evolution of component-based development.

The current efforts toward component-based development are aimed at the software development community. However, as interface layers are added to the underlying plumbing of programming, the ease of developing useful applications from reusable components is increasing. As these interface layers improve, the programming expertise required of the developer decreases. The current state of the art does not enable every non-programmer end-user to write software; that is, using any modern programming language still requires some programming skill. How can we enable military and commercial end-users of limited programming ability to successfully combine reusable components into software agents capable of assisting their daily operations? Or, what type of interface layer is required to sufficiently hide the details of agent creation and reduce the required amount of programming skill to almost nothing?

### SUMMARY OF THE INVENTION

The present invention is a system for creating autonomous and semi-autonomous software agents from reusable components. The system requires a computer, including an operating system providing access to platform-specific hardware and software. On this computer must exist a set of software components performing specialized tasks within larger software components or as stand-alone applications. These components must exist as atomic entities to be independently manipulated within the given operating system. Also required is a set of ontologies describing knowledge domains of interest for agent operations. In this disclosure, an ontology is defined as a metadata description of data and procedural models for a specific knowledge domain. Finally, there is an agent creation program combining relevant software components into software agents based on the available ontologies. These software agents then perform automated operations to provide value-added results based on end-user goals and preferences.

Another embodiment of the present invention includes a set of component metadata relating all available software components to relevant ontologies for automated combination of components into software agents.

A third embodiment of the present invention includes a set of interfaces for end-user creation of software agents using the agent creation program. These interfaces map end-user goals and preferences to agent behavior based on relevant and available ontologies and component metadata.

A fourth embodiment of the present invention includes a set of communications interfaces providing a distributed architecture for the agent creation process. In this distributed architecture, the agent creation program, interfaces, ontologies, software components, component metadata, created software agents, and end-user results exist on the same computer or on separate computers on a network.

### BRIEF DESCRIPTION OF THE DRAWINGS

FIG. 1 is a schematic which shows the general process involved in the present invention. The left-hand side shows the invention on a single computer. The right-hand side shows a distributed embodiment of the invention.

FIG. 2 is a flow chart showing the process of ontology-based agent creation.

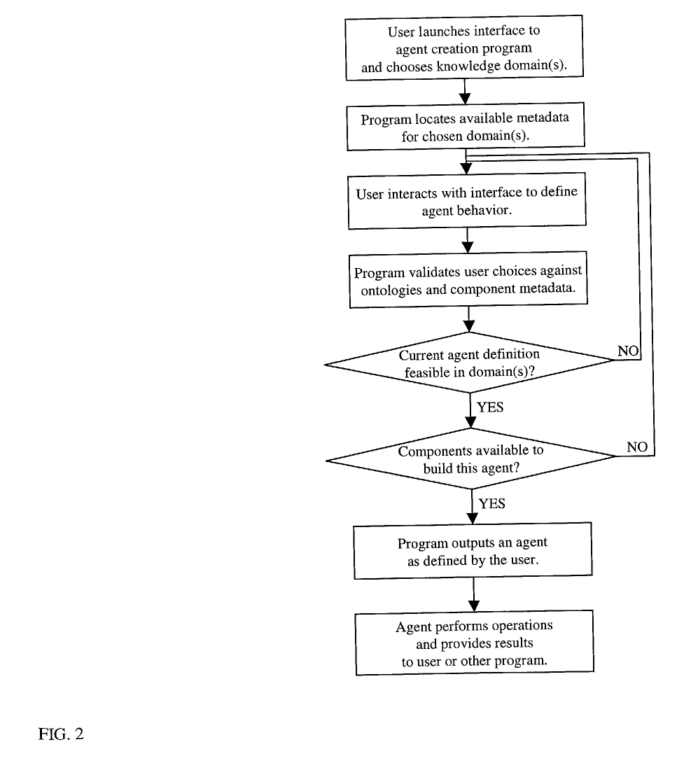

FIG. 3 shows screen shots of a Requirements Wizard agent creation interface developed under contract with the Defense Advanced Research Projects Agency (DARPA).

FIG. 4 shows a generalized, multiple knowledge domain agent creation interface developed under contracts with the Army and Air Force.

FIG. 5 shows screen shots from the Systems Integration Requirements Wizard, a domain-specific extension of the generalized interface in FIG. 4.

FIG. 6 shows another agent creation interface developed for the Army and Air Force, allowing end-user drag-and-drop of components onto a palette for agent creation.

FIG. 7 shows another agent creation interface developed for DARPA that displays a data model description to allow metadata keyword selection for agent search.

### DETAILED DESCRIPTION OF THE INVENTION

In the background above we posed the following question: what type of interface layer is required to sufficiently hide the details of agent creation and reduce the required amount of programming skill to almost nothing? The required interface layer consists of domain-specific ontologies defining data and procedural models within knowledge and computing domains of interest for agent development. A knowledge domain as used here includes tightly- and loosely-coupled data types and operations within military and commercial applications, including environmental, command and control, search and surveillance, marketing, managing, etc. A computing domain includes the resources available on the operator's machine and on the network, such as data sources (e.g. Oracle database, Web server, human expert), transport protocols (e.g. HTTP, FTP), middleware solutions (e.g. CORBA, Web Services), and software components capable of performing operations within specific knowledge domains. Data types within a knowledge domain's data model are represented using an appropriate schema (e.g. XML). Operations within the domain's procedural model are represented using an appropriately defined grammar (e.g. Backus-Naur Form (BNF)) and include data source location, dynamic data source discovery, data retrieval, translation, storage, and display. Domain-specific ontologies describing the resources, operations, and software components available within limited knowledge and computing domains empower end-users to combine those software components into software agents based on clearly understood requirements within their daily operations.

For example, an operator responsible for generating a daily weather report, requiring multiple types and formats of environmental data from multiple data sources, would benefit from an agent assistant built from components performing data retrieval, translation, and display within the environmental knowledge domain. The agent could gather the required data from the available data sources (as defined within the computing domain), translate each data format into a standard common format for display or ingest into a common database, and provide the operator with his or her preference of updates and alerts regarding the status of the operation. In addition, an agent assistant could be commanded to spend its downtime (i.e. when the operator hasn't tasked it to a specific operation) looking for alternative data sources on the LAN or on the Web, extending this agent to dynamic data source discovery. Creating this agent assistant requires the existence of specialized components within the environmental knowledge domain capable of recognizing and translating the types and formats of the environmental data required, as well as specialized components capable of performing data location, retrieval, and display with regard to the data sources within the computing domain of the end-user's network.

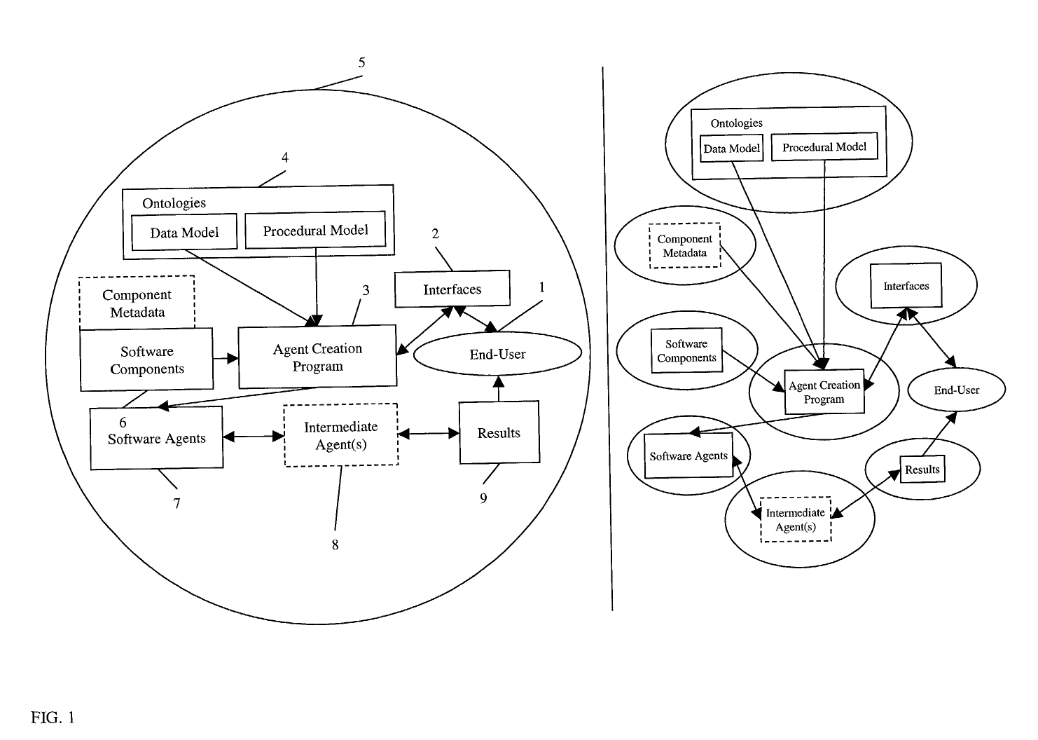

Building Agents from Components. The schematic shown in FIG. 1 shows the general process of the present invention. The end-user (1), which can be either a human user or a software program, interacts with the agent creation program (2) through one or more of its interfaces (3) to define agent behavior within the limitations of the chosen knowledge domain(s) (4) and the given computing domain(s) (5 and right-hand side of figure). The agent creation program utilizes the ontologies defining these domains to combine reusable software components (6) into one or more software agents (7) to perform operations as defined by the end-user. The created agents make use of any necessary intermediate agents (7) for ancillary translation, retrieval, or other processing, and finally provide the required results (8) to the end-user.

The first step in devising the present invention was to describe agent behavior as the interaction of conceptual components performing specialized operations (e.g. get, put, translate, display). From this initial approach, we have a generalized grammar describing potential agent operations within specific knowledge domains. The following portion of a modified Backus-Naur grammar partially describes the conceptual component operations “get”, “put”, and “translate”:

get::=<object> from <data_source>

put:: <object> to <data_source>

translate::=<object> to <object>

display::=<object> on<object_viewer>

object::=<domain specific>

object_viewer::=<domain specific>

data_source::=<database>|<file>|<serial>|<internet>|<program>|<domain specific>

database::=Informix|Access|Oracle|<domain specific>

file::=<ascii>|<binary>

ascii::=XML|HTML|<domain specific>

binary::=JPEG|GIF|MS_WORD|<domain specific>

serial::=<rs-232>|<domain specific>

rs-232::=<ascii>|<binary>

internet::=HTTP|FTP|SOAP|<domain specific>

program::=Agent|ORB|COM_Server|<domain specific>

Those components that retrieve data objects from databases, the Internet, files, serial ports, other programs, etc. perform “get” operations. Those components that write data objects to files, databases, serial ports, etc. perform “put” operations. Between a “get” and a “put” might be a component to “translate” the data object form the source's format into the format of the receiver. These conceptual components are atomic entities, each describing a single operation. By devising a generalized grammar for agent behavior, we have formed the basis for the description of actual software components performing multiple operations within an application. The next step was to connect this conceptual approach to real-world applications.

Domain-specific ontologies provide the mapping of conceptual component descriptions to actual software systems within specific knowledge domains. An ontology is a definition of the elements of a knowledge domain (i.e. from philosophy, those things that “exist” within the knowledge domain) and the relationships among them. The <domain specific> elements shown in the above grammar represent those elements that are not generalized to every type of conceptual component, but instead directly correspond to a specific ontology. As defined in this approach, an ontology for a specific knowledge domain is represented by a data model, which defines the types of data objects to be manipulated and their relationships to each other, and a procedural model, which defines the types of operations that can be performed on the given data types.

The data model is the definition of structure among data elements in the domain. For example, the following is a portion of an XML Schema definition for a complex data type, called forecast, to be used within environmental data transactions. The data type consists of several fields in sequence, including type, time, and location, each of which refers to other data types defined by other schemas, including time (e.g. either GMT or epoch time) and position (e.g. defining the forecast for a point or an area):

<?xml version=“1.0”?>
<xsd:schema targetNamespace=“http:wwww.wagner.com/metoc.xsd”
xmlns:xsd=“http://www.w3.org/2001/XMLSchema”
xmlns:time=“http://www.wagner.com/time.xsd”
xmlns:pos=“http://www.wagner.com/space.xsd”
xmlns=“http://www.w3.org/2001/XMLSchema”>
<element name=“forecast”>

<complexType>

<sequence>
<element name=“forecastType” type=“tns:forecastType”/>

<choice>

<element name=“time” type=“time:gmt”/>
<element name=“time” type=“time:epoch”/>

</choice>
<choice>

<element name=“location” type=“space:latlonPoint”/>
<element name=“location” type=“space:latlonBox”/>

</choice>

</sequence>

</complexType>

</element>
<element>

(other elements, such as “parameter”, are defined here)

</element>

</schema>

The values assigned to these elements within metadata descriptions make up the knowledge domain's vocabulary, which may be defined by the data model or may be application-specific (i.e. agreed upon between applications using this data model). This type of data model description document, existing as a DTD, an XML schema, or any other structured format, defines the data model definition for each knowledge domain.

The data model describes both the data objects passed between software components and the computing domain, or infrastructure, of interest. The infrastructure description might exist as a document written in XML, as a CORBA Repository, or as any other valid description of resources available on the network. This description would make use of the given data model's structure and vocabulary, whether implied by use in this document or defined in a data model description, to describe the infrastructure on which agents operate for the given knowledge domain. For example, the following partial infrastructure document uses elements from the METOC schema partially listed above, another schema for sensor types, and yet another schema for device types to describe a sensor network on which agents retrieve, process, and visualize METOC data:

<?xml version=“1.0”?>
<infrastructure

xmlns:sensors=“http://www.wagner.com/sensors.xsd”
xmlns:devices=“http://www.wagner.com/devices.xsd”
xmlns:metoc=“http://www.wagner.com/metoc.xsd”
xmlns=“http://www.wagner.com/infrastructure.xsd”>
<sensors:sensor id=“120” format=“RS-232”>

<metoc:parameter units=“K”>temperature</metoc:parameter>
<metoc:period units=“minutes”>1</metoc:period>

</sensors:sensor>
<sensors:sensor id=“185” name=“WindSensor 3000” format=“RS-232”>

<metoc:parameter units=“KTS”>wind speed</metoc:parameter>
<metoc:parameter units=“DEG T”>wind direction</metoc:parameter>

</sensors:sensor>
<devices:display id=“34452-K” name=“Xybernaut” type=“wearable”>

<format>JPEG</format>
<format>HTML</format>

</devices:display>

</infrastructure>

This description shows that there is a sensor with ID 120 that outputs temperature in Kelvin every minute. It also shows that there is a display system called a Xybernaut that is a wearable device capable of displaying the browser-oriented formats JPEG and HTML. By describing the given infrastructure using the given schemas, we link the physical sensor network to the conceptual behavior of software agent components on that network. The more detail provided by this description, the more effective the agent creation process when attempting to meet user requirements, as discussed below. The elements used in this infrastructure description document can be defined in a data model description, such as the one shown above, or simply accepted as stand-alone metadata (e.g. well-formed XML).

The procedural model is the definition of operations on data model elements in the domain and is derived from the generalized grammar defined above. The following portion of a modified Backus-Naur grammar continues our METOC example by defining actions within the infrastructure described above:

get:=<parameter>+from <sensor>+[during <timerange>+]

translate:=<parameter>+from <units> to <units>

translate:=<parameter>+from <format> to <format>

display:=<parameter>+on<display>[as<format>]

This document (which could also be written as an XML schema) states that agents within this domain can perform operations such as “Get temperature from sensor23 during 1000-1200,” or “Translate wind speed, wind direction from GRIB to ASCII,” or “Display temperature, wind speed, wind direction on Xybernaut as HTML.” The grammar defines what operations are available for agents to accomplish on the given infrastructure within the given domain. Existence of an operation within the grammar does not imply the existence of an agent component capable of performing such an operation. However, in order to develop an agent capable of performing a specific operation, there must be an agent component to perform that operation within the limitations of the given domain and network. If there is no procedural model provided for a specific domain, then the agent creation process is still possible via end-user manipulation of agent components within a graphical interface.

The final requirement for a fully automated system is a component description document defining the relationship between the procedural model and the software components available for agent creation. These components might exist as any type of programming entity, such as C++ or Java classes, Perl scripts, Java Beans, CORBA objects, COM clients/servers, stand-alone applications, Web Services, or any other type of software. For example, the following component description defines Java Bean components performing operations as described in our METOC example:

<?xml version=“1.0”?>
<components

xmlns:sensors=“http://www.wagner.com/sensors.xsd”
xmlns:metoc=“http://www.wagner.com/metoc.xsd”
xmlns:grammar=“http://www.wagner.com/grammar.xsd”
xmlns=“http://www.wagner.com/components.xsd”>
<component>

<id>12</id>
<name>get_winds.class</name>
<location type=“url”>23.334.99\source\beans</location>
<language>Java</language>
<type>Bean</type>
<grammar:get>

<metoc:parameter>wind speed</metoc:parameter>
<metoc:parameter>wind direction</metoc:parameter>
<from>

<sensors:sensor format=“RS-232”/>

</from>

</grammar:get>
<grammar:put>

<meroc:parameter units=“KTS”>wind speed</metoc:parameter>
<metoc:parameter units=“DEG T”>wind direction</metoc:parameter>
<to>

<file>

<name>winds.xml./name>
<location type=“url”>23.334.99\data</location>
<format>XML</format>

</file>

</to>

</grammar:put>

</component>
<component>

<id>34</id>
<name>GRIB_to_ASCII.class</name>
<location type=“url”>23.334.99\source\beans</location>
<language>Java</language>
<type>Bean</type>
<grammar:translate>

<from>GRIB</from>
<to>ASCII format 32</to>

</grammar:translate>

</component>

</components>

This example shows that agent component 12, called get_winds.class, can retrieve wind speed and direction from an RS-232 serial port and output that data in an XML document. Also according to the description, component 34 can translate gridded binary (GRIB) data to ASCII text. The use of XML namespaces in this example allows us to specify the knowledge domain(s) that our components intersect in their operations. With these descriptions of the inputs/outputs, types, and behavior of components, we are able to dynamically (with no user interaction) combine the proper components into one or more software agents by simply mapping user requirements to component capabilities using the same ontologies. The level of detail in these descriptions determines the effectiveness of the created agents in terms of the end-user's original goals. Each component communicates with other programming entities on the computer network using either its own inherent interface (e.g. COM, CORBA, SOAP) or through specialized translation entities providing access to required interfaces.

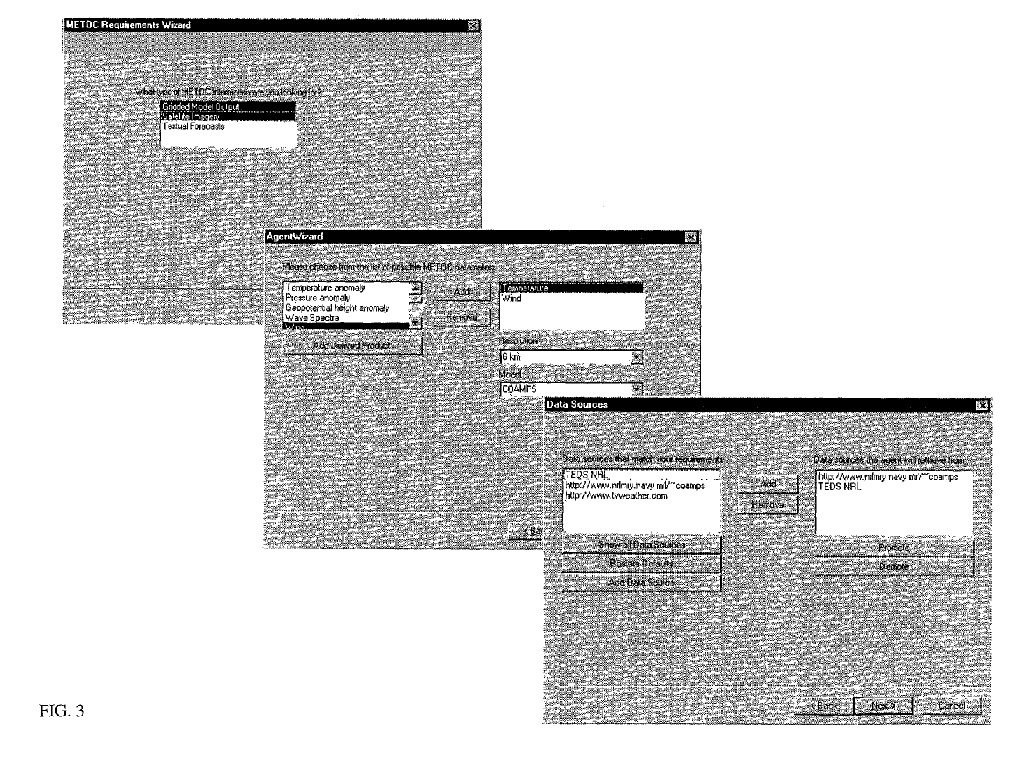

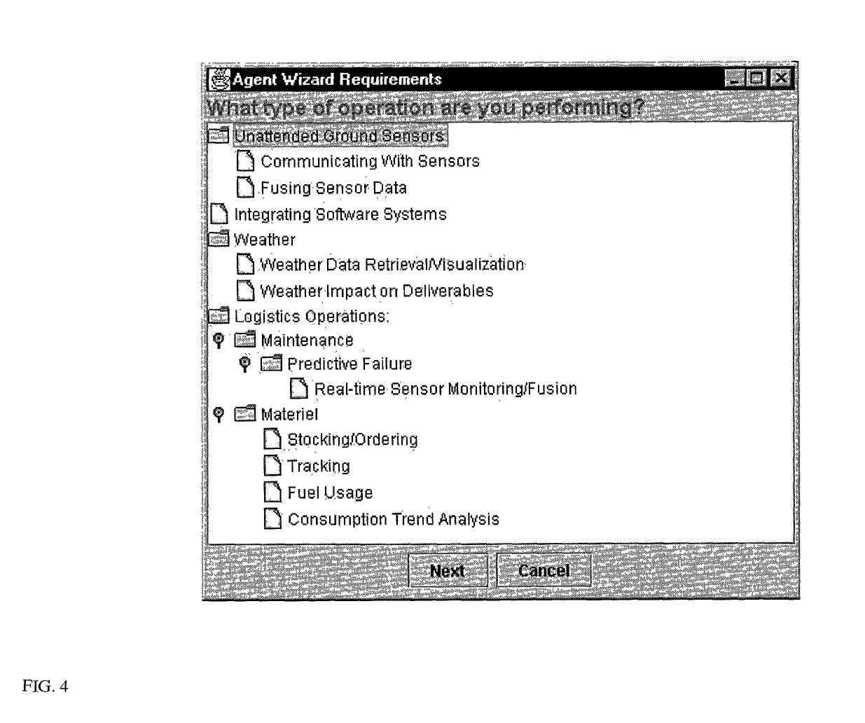

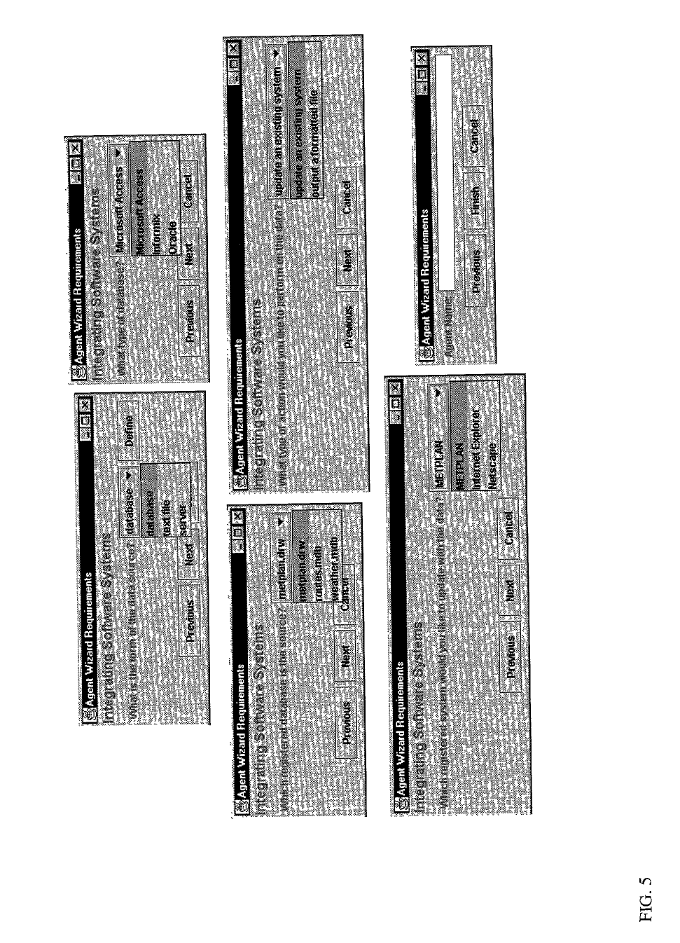

Agent Creation Interfaces. The graphical interfaces associated with this invention allow end-users to specify their goals and preferences in terms of the knowledge domains in which they are operating. FIG. 3 shows screen shots of an agent creation interface developed under contract with the Defense Advanced Research Projects Agency (DARPA). This interface, a METOC-specific Requirements Wizard, steps the end-user through the definition of METOC-specific agent behavior. FIG. 4 shows another agent creation interface developed under contracts with the Army and Air Force. This interface is a more generalized (and more powerful) interface because it provides access to agent creation within several knowledge domains, including system integration, weather, unattended ground sensors, and logistics. FIG. 5 shows screen shots taken while defining systems integration requirements. The first screen asks the user to choose the type of data source that is being integrated. If the type is not in the list, the user has the option of defining a new data source type. Choosing “database” in this first screen and clicking “Next” brings up the second screen, in which the user chooses the specific type of database that's being integrated. In the next screen, the user chooses from databases that have a registered entry with the agent creation program (i.e., they have a metadata description, as described below). The next screen asks what the user wants the agent to do with the data from the data source. Choosing to update an existing system results in the next screen, in which they enter the registered system to be updated (again, this system must have a metadata description). Finally, when the user clicks “Next” the Requirements Wizard asks for a name for the agent to be created.

Each interface developed for a domain-specific application (e.g. Requirements Wizard) requires programming. A programmer developed each of the screens in FIG. 5 for the specific purpose of being displayed within that particular Requirements Wizard. This represents the tradeoff between ease of development and ease of use. In order for end-users with very little technical expertise to be able to easily develop agents to assist their daily operations, time and money must be put into the development of this type of step-by-step interface. An alternative approach is to develop a generic interface that allows for the creation of agents within any application domain, but requires more technical expertise on the part of the end-user.

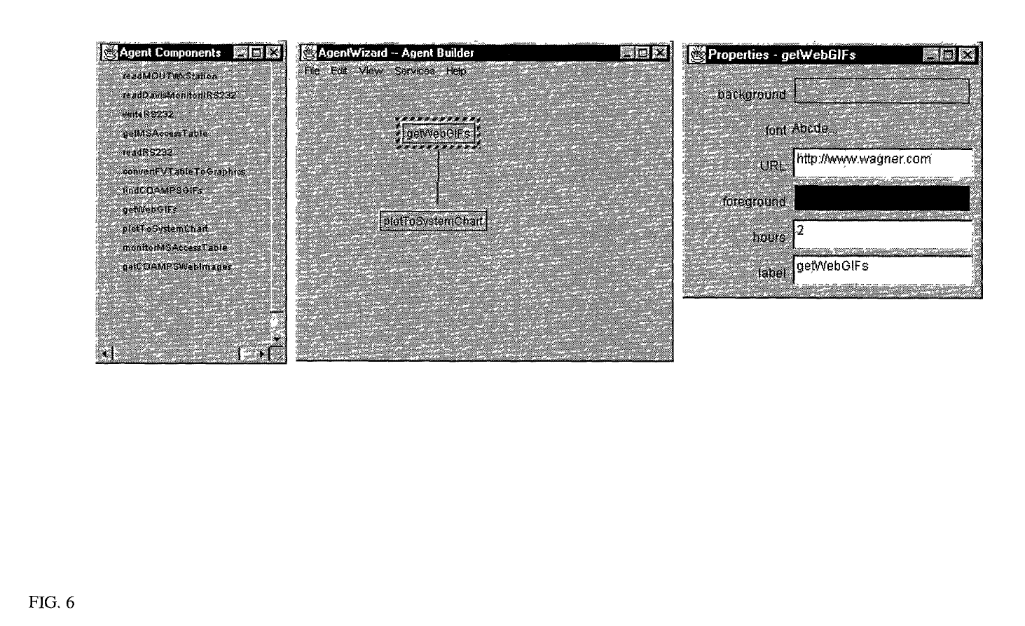

FIG. 6 shows a prototype interface for creating software agents through direct component manipulation. This interface is a simple Java Bean manipulation demonstration that allows technically inclined end-users to combine Java Bean agent components into working agents. The leftmost screen shows the Agent Component Toolbox, which contains all the components currently known to the agent creation program (i.e. that currently have metadata descriptions). The middle screen shows the Agent Builder palette where components are combined into a working agent. In this example, the user has dragged and dropped two components from the toolbox, getWebGIFs and plotToSystemChart, and placed them on the palette. The red line between the components shows that an event or property from the first component is bound to the second component, which means that the second component's behavior is linked to that of the first (e.g. plotToSystemChart won't activate until getWebGIFs fires an event stating that it has retrieved imagery to display). The rightmost screen shows the Properties window, which shows the user the bound properties for the selected component. This interface enforces component connections based on their metadata descriptions, permitting compatible components to be connected and warning of incompatibilities in data types, formats, etc. This type of interface provides the user with direct control over the creation of an agent, but it also requires more technical understanding than a requirements-driven interface.

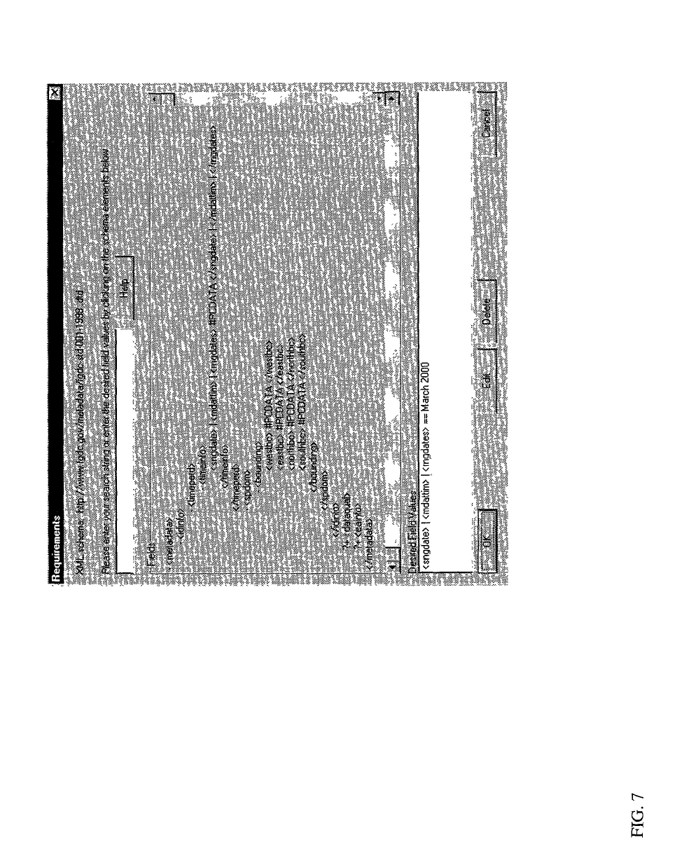

FIG. 7 shows an interface to the agent creation process that displays a data model description (in this case an XML DTD) to allow the end-user to select keywords from the data model that are of particular interest. These keywords provide targets for agent search and retrieval from local or remote data sources. By searching directly on the data model, instead of requiring the end-user to fabricate appropriate keywords, agent search becomes much more efficient. Instead of searching HTML documents on the Web for matching keywords (e.g. looking for the keyword “stock quote” on millions of HTML pages), agents can focus search on those data sources providing metadata specifically matching that keyword (e.g. Charles Schwab's web site).

What is claimed is:

1. A system for creating autonomous and semi-autonomous software agents from reusable software components, comprising:
a) a computer, including an operating system providing access to platform-specific hardware and software;
b) a set of software components on said operating system, said software components existing as atomic entities exposed for human or machine manipulation on said operating system and performing specialized tasks within larger software components or as stand-alone applications;
c) a set of ontologies describing knowledge domains, said ontologies being metadata descriptions of data and procedural models and existing in human-readable or machine-readable form on said operating system;
d) an agent creation program combining said software components into software agents based on said ontologies, said software agents providing results based on end-user goals and preferences.

2. A system according to claim 1, additionally comprising:
a set of component metadata relating said software components to said ontologies for automated combination of software components into software agents.

3. A system according to claim 1, additionally comprising:
a set of interfaces for creation of software agents using said agent creation program.

4. A system according to claim 1, additionally comprising:
a set of communications interfaces providing a distributed architecture for said agent creation program, said ontologies, said software components, and said software agents.
